(19) United States
(12) Patent Application Publication
(10) Pub. No.: US 2019/0272744 A1
(43) Pub. Date: Sep. 5, 2019

(54) VEHICLE CONTROL DEVICE

(71) Applicant: HONDA MOTOR CO., LTD., Tokyo (JP)

(72) Inventors: Toshifumi SUZUKI, WAKO-SHI (JP); Hiroshi MIURA, WAKO-SHI (JP); Suguru YANAGIHARA, WAKO-SHI (JP); Marina SAIKYO, WAKO-SHI (JP)

(21) Appl. No.: 16/290,006

(22) Filed: Mar. 1, 2019

(30) Foreign Application Priority Data
Mar. 2, 2018 (JP) 2018-037116

(51) Int. Cl. G08G 1/01; G05D 1/00; G08G 1/04; B60W 10/20; B60W 10/18; B60W 30/18

(52) U.S. Cl. CPC G08G 1/0125; G05D 1/0088; G08G 1/04; B60W 10/20; B60W 10/18; B60W 2720/106; G05D 2201/0213; B60W 2420/42; B60W 2550/30; B60W 2710/20; B60W 2710/18; B60W 30/18

(57) ABSTRACT

An action planning unit determines an amount of deceleration of a host vehicle corresponding to a traffic regulation on the basis of at least one item of information from among a situation of other vehicles traveling in a second travel path recognized by an external environment recognition unit, a number of the other vehicles traveling in the second travel path, a speed limit of the second travel path, and environmental information of the second travel path.

### CROSS-REFERENCE TO RELATED APPLICATION

This application is based upon and claims the benefit of priority from Japanese Patent Application No. 2018-037116 filed on Mar. 2, 2018, the contents of which are incorporated herein by reference.

### BACKGROUND OF THE INVENTION

### Field of the Invention

The present invention relates to a vehicle control device adapted to automatically drive or provide driving assistance to a host vehicle.

### Description of the Related Art

In the case that two travel paths are connected (including intersecting and merging travel paths), a priority relationship between the travel paths is determined based on a traffic regulation. For example, when a first vehicle travels on a first travel path having a high priority, a second vehicle travels on a second travel path having a lower priority, and the first vehicle and the second vehicle approach toward one another substantially at the same time at a connecting position between the first travel path and the second travel path, the second vehicle is required to decelerate or come to a stop, and allow the first vehicle to pass through the connecting position first. For this reason, it is necessary for an occupant of the second vehicle to recognize the traffic regulation in advance by way of a road sign or the like.

In Japanese Patent No. 4225189, a device is disclosed in which, based on information acquired from a road sign or the like at the connecting position between a first travel path on which a host vehicle travels and a second travel path on which another vehicle travels, a priority relationship between the first travel path and the second travel path is determined, and a notification of the determination result is issued with respect to an occupant of the host vehicle.

### SUMMARY OF THE INVENTION

In Japanese Patent No. 4225189, in the case that the priority of the first travel path is lower than that of the second travel path, it is necessary for the host vehicle to be decelerated so that the other vehicle can pass through the connecting position first. At this time, it is assumed that the host vehicle travels at a high speed up to the connecting position, and then rapidly decelerates at the connecting position. An occupant of another vehicle traveling in the second travel path, while observing the host vehicle traveling at a high speed, may misperceive that the host vehicle is intending to enter into the first travel path while staying at the high speed, and there is a possibility that the occupant of the other vehicle will carry out an action to avoid the approach of the host vehicle. Upon doing so, there is a concern that the flow of traffic in the second travel path will be disturbed.

Incidentally, an automatically driven vehicle (including a driving assisted vehicle) has been developed in which a vehicle control device performs an acceleration/deceleration control. In the case that an automatically driven vehicle serving as a host vehicle (driver's own vehicle) is traveling in the first travel path having a lower priority than the second travel path, then when the host vehicle is made to decelerate or temporarily stop before reaching the second travel path, it is necessary for the vehicle control device to carry out a deceleration control so as not to disturb the flow of traffic in the second travel path.

The present invention has been devised taking into consideration the aforementioned problem, and has the object of providing a vehicle control device which is capable of appropriately causing a host vehicle, which is traveling in a first travel path having a priority lower than that of a second travel path, to undergo deceleration before reaching the second travel path.

A vehicle control device according to a first aspect of the present invention comprises an external environment recognition unit adapted to recognize a state of a periphery around a host vehicle, an action planning unit adapted to determine an action of the host vehicle on the basis of a recognition result of the external environment recognition unit, and a vehicle control unit adapted to carry out a travel control for the host vehicle on the basis of content of the action planned by the action planning unit, wherein, in the case that the external environment recognition unit recognizes a first travel path on which the host vehicle travels, a second travel path that connects with the first travel path, and a traffic regulation which determines that a priority of the second travel path is higher than a priority of the first travel path, the action planning unit determines an amount of deceleration of the host vehicle corresponding to the traffic regulation, on the basis of at least one item of information from among a situation of other vehicles traveling in the second travel path recognized by an external environment recognition unit, a number of the other vehicles traveling in the second travel path, a speed limit of the second travel path, and environmental information of the second travel path.

In accordance with the above-described configuration, by determining the amount of deceleration of the host vehicle on the basis of the condition of the second travel path, which has a higher priority than the first travel path in which the host vehicle travels, it is possible for the host vehicle to be decelerated appropriately before reaching the second travel path.

In the first aspect of the present invention, in the case of recognizing a situation in which a traffic participant existing in the second travel path cannot be detected, the external environment recognition unit may recognize an amount of deceleration of a preceding vehicle traveling in front of the host vehicle, and the action planning unit may determine an amount of deceleration of the host vehicle on the basis of the amount of deceleration of the preceding vehicle.

In accordance with the above-described configuration, by determining the amount of deceleration of the host vehicle on the basis of the preceding vehicle, it is possible for the host vehicle to be decelerated appropriately before reaching the second travel path.

Further, the amount of deceleration itself can be easily determined.

In the first aspect of the present invention, there may further be provided a camera adapted to capture an image and acquire image information of indicators that indicate the traffic regulation, wherein, in the case that the external environment recognition unit recognizes the traffic regulation on the basis of the image information, the action planning unit may change a distance that the host vehicle travels in a decelerated state in accordance with a number of the indicators.

As the number of indicators such as road signs or the like increases, the distance that the host vehicle travels in the decelerated state increases. In accordance with the above-described configuration, by changing the distance that the host vehicle travels in the decelerated state in accordance with the number of the indicators, it is possible for the host vehicle to be decelerated more appropriately before reaching the second travel path.

In the first aspect of the present invention, there may further be provided a host vehicle communication device adapted to perform communications with an external communication device disposed externally of the host vehicle, and acquire external environmental information including information of an amount of traffic, wherein the external environment recognition unit may recognize the amount of traffic in the second travel path on the basis of the external environmental information, and the action planning unit may change the amount of deceleration of the host vehicle in accordance with the amount of traffic in the second travel path.

In accordance with the above-described configuration, by changing the amount of deceleration in accordance with the amount of traffic in the second travel path, it is possible to decelerate the host vehicle more appropriately before reaching the second travel path.

In the first aspect of the present invention, the external environment recognition unit may recognize a position of the first travel path and a position of the second travel path, and the action planning unit may determine a degree of recognizability which indicates a degree to which the first travel path can be recognized from the second travel path on the basis of the position of the first travel path and the position of the second travel path, and may change the amount of deceleration of the host vehicle in accordance with the degree of recognizability.

In a situation in which it is difficult to recognize the second travel path from the first travel path, the other vehicle may recognize the host vehicle for the first time in the vicinity of the connecting position between the first travel path and the second travel path. At this time, if the travel velocity of the host vehicle is high, there is a possibility that an occupant of the other vehicle may operate the brakes rapidly or on the spur of the moment. Upon doing so, the flow of traffic in the second travel path is obstructed. In accordance with the above-described configuration, by changing the amount of deceleration in accordance with the degree to which the first travel path can be recognized from the second travel path, it is possible to decelerate the host vehicle more appropriately before reaching the second travel path, and the flow of traffic in the second travel path can be maintained.

In the first aspect of the present invention, there may further be provided a map storage unit in which map information is stored including information indicative of a type of road, wherein the external environment recognition unit may recognize the types of the first travel path and the second travel path on the basis of the map information, and the action planning unit may change the amount of deceleration of the host vehicle in accordance with the types of the first travel path and the second travel path.

The appropriate amount of deceleration differs between a case in which merging with a main line (the second travel path) takes place at an expressway, and a case in which merging with the main line takes place at a general road. In accordance with the above-described configuration, by determining the amount of deceleration in accordance with the types (an expressway, a general road) of the first travel path and the second travel path, it is possible to decelerate the host vehicle more appropriately before reaching the second travel path.

In the first aspect of the present invention, in the case that the vehicle control unit has caused the host vehicle to stop before reaching the second travel path, the action planning unit may determine to alternately perform stopping and traveling of the host vehicle in the first travel path, until the external environment recognition unit recognizes that the other vehicles do not exist which are traveling in the second travel path toward a connecting position between the first travel path and the second travel path.

In the case that the host vehicle stops before reaching the connecting position between the first travel path and the second travel path, in certain cases, it may be difficult to recognize the other vehicle from the stopped position. In this case, it is preferable to cause the host vehicle to move to a position where the other vehicle can be more easily recognized. In the above-described configuration, it is determined to alternately perform stopping and traveling of the host vehicle in the first travel path, and by executing such an action, it is possible to cause the host vehicle to be moved to a position where it is easy to recognize the presence or absence of the other vehicle in the vicinity of the connecting position.

In the first aspect of the present invention, the action planning unit may change the amount of deceleration of the host vehicle in accordance with a travel velocity of the host vehicle before the external environment recognition unit recognizes the traffic regulation, or a speed limit of the first travel path that is recognized by the external environment recognition unit.

In the case that the travel velocity of the host vehicle is decelerated to a predetermined velocity or less, the amount of deceleration differs depending on the travel velocity prior to deceleration of the host vehicle. In accordance with the above-described configuration, by determining the amount of deceleration in accordance with the travel velocity of the host vehicle or the speed limit of the first travel path, it is possible to decelerate the host vehicle more appropriately before reaching the second travel path.

A vehicle control device according to a second aspect of the present invention comprises an external environment recognition unit adapted to recognize a state of a periphery around a host vehicle, an action planning unit adapted to determine an action of the host vehicle on the basis of a recognition result of the external environment recognition unit, and a vehicle control unit adapted to carry out a travel control for the host vehicle on the basis of content of the action planned by the action planning unit, wherein, in the case that the external environment recognition unit recognizes a first travel path on which the host vehicle travels, and a second travel path that connects with the first travel path, the action planning unit changes a distance up to which it is acceptable for the host vehicle to come into proximity with respect to other vehicles that travel in the second travel path, depending on a case of the external environment recognition unit recognizing and a case of the external environment recognition unit not recognizing a traffic regulation by which a priority of the second travel path is higher than a priority of the first travel path.

In accordance with the above-described configuration, since the distance up to which it is acceptable for the host vehicle to come into proximity with respect to the other vehicles is changed, it is possible to hasten the timing at which the host vehicle begins to decelerate. As a result, it is possible for the host vehicle to be made to decelerate appropriately before reaching the second travel path.

According to the present invention, it is possible for the host vehicle to be made to decelerate appropriately before reaching the second travel path.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a block diagram of a host vehicle equipped with a vehicle control device according to first and second embodiments of the present invention;

FIG. 2 is a functional block diagram of a computation device;

FIG. 3 is a flowchart of processing steps performed by the vehicle control device according to the first embodiment;

FIG. 4 is a diagram for explaining the vehicle control performed by the host vehicle.

FIG. 5 is a flowchart of processing steps performed by the vehicle control device according to the second embodiment; and

FIG. 6A and FIG. 6B are diagrams schematically showing an approach enabled distance.

### DESCRIPTION OF THE PREFERRED EMBODIMENTS

A preferred embodiment of a vehicle control device according to the present invention will be presented and described in detail below with reference to the accompanying drawings.

### A. First Embodiment

### 1. Configuration of Host Vehicle 10

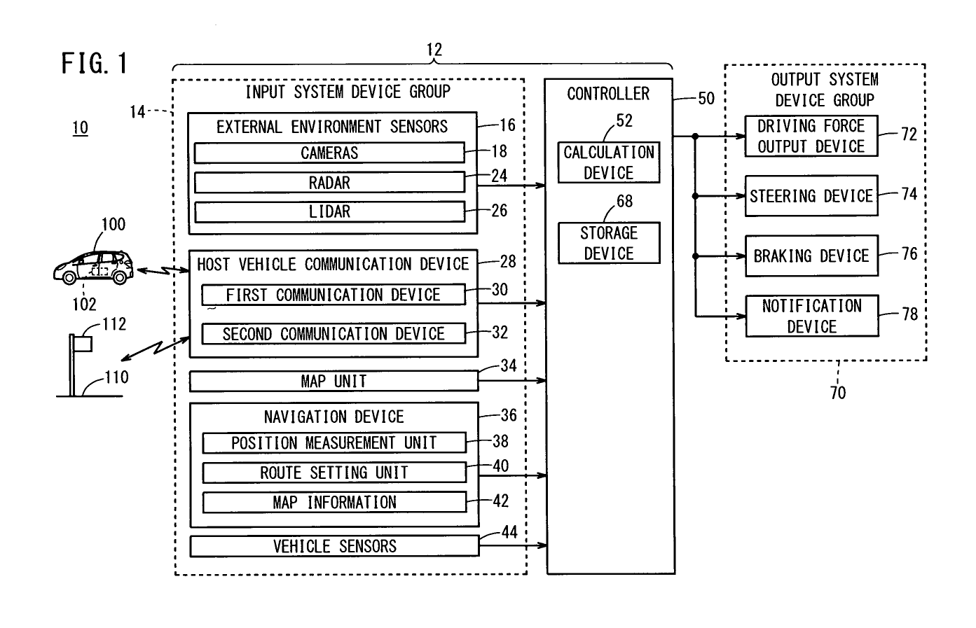

As shown in FIG. 1, the host vehicle 10 is equipped with an input system device group 14 which acquires or stores various information, a controller 50 to which information that is output from the input system device group 14 is input, and an output system device group 70 which is operated in response to various instructions output from the controller 50. A vehicle control device 12 according to the present embodiment includes the input system device group 14 and the controller 50. The host vehicle 10 is an automatically driven vehicle (including a fully automatically driven vehicle) in which a travel control is performed by the controller 50, or a driving assisted vehicle in which portions of the travel control are assisted by the controller 50.

### [1.1. Input System Device Group 14]

In the input system device group 14, there are included external environment sensors 16, a host vehicle communication device 28, a map unit 34, a navigation device 36, and vehicle sensors 44. The external environment sensors 16 detect the state of the surrounding periphery (external environment) of the host vehicle 10. Among the external environment sensors 16, there are included a plurality of cameras 18 that capture images of the external environment, a plurality of radar devices 24 and one or more LIDAR devices 26 that detect the distance between the host vehicle 10 and other surrounding objects, as well as the relative velocity between the host vehicle 10 and the surrounding objects. In the host vehicle communication device 28, there are included a first communication device 30 and a second communication device 32. The first communication device 30 performs inter-vehicle communications with other vehicle communication devices 102 provided in other vehicles 100, and acquires external environmental information including information (a type of car, a travel state, a traveling position, etc.) of the other vehicles 100. The second communication device 32 performs road-to-vehicle communications with roadside communication devices 112 provided in infrastructure of a road 110 or the like, and acquires external environmental information including road information (information in relation to traffic signals, traffic congestion information, and the like). The map unit 34 stores high precision map information including information such as the number of lanes, the lane type, the lane width, and the like. The navigation device 36 comprises a positioning unit 38 that measures the position of the host vehicle 10 by way of satellite navigation and/or autonomous navigation, map information 42, and a route setting unit 40 which sets a planned route from the position of the host vehicle 10 to a destination on the basis of the map information 42.

Hereinafter, unless otherwise specified, the high precision map stored in the map unit 34, and the map information 42 stored in the navigation device 36 will be collectively referred to as the map information 42. The vehicle sensors 44 detect the travel state of the host vehicle 10. The vehicle sensors 44 include a vehicle velocity sensor, an acceleration sensor, a yaw rate sensor, an inclination sensor, a travel distance sensor (mileage sensor) and the like, none of which are shown.

### [1.2. Output System Device Group 70]

In the output system device group 70, there are included a driving force output device 72, a steering device 74, a braking device 76, and a notification device 78. The driving force output device 72 includes a driving force output ECU and a drive source such as an engine or a driving motor. The driving force output device 72 generates a driving force in accordance with an operation of an accelerator pedal performed by the vehicle occupant, or a driving control instruction output from the controller 50. The steering device 74 includes an electric power steering system (EPS) ECU and an EPS actuator. The steering device 74 generates a steering force in accordance with an operation of the steering wheel performed by the vehicle occupant, or a steering control instruction output from the controller 50. The braking device 76 includes a brake ECU and a brake actuator. The braking device 76 generates a braking force in accordance with an operation of the brake pedal performed by the vehicle occupant, or a braking control instruction output from the controller 50. The notification device 78 includes a notification ECU, and an information transmission device (a display device, an audio device, a haptic device, etc.). The notification device 78 issues a notification with respect to the vehicle occupant in accordance with a notification instruction output from the controller 50 or another ECU.

### [1.3. Controller 50]

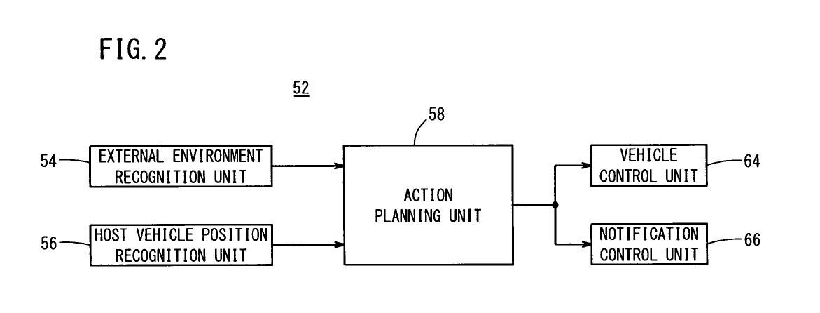

The controller 50 comprises an ECU, and includes a computation device 52 such as a processor, and a storage device 68 such as a ROM and a RAM. The controller 50 realizes various functions by the computation device 52 executing programs stored in the storage device 68. As shown in FIG. 2, the computation device 52 functions as an external environment recognition unit 54, a host vehicle position recognition unit 56, an action planning unit 58, a vehicle control unit 64, and a notification control unit 66.

On the basis of information output from the external environment sensors 16, the host vehicle communication device 28, the map unit 34, and the navigation device 36, the external environment recognition unit 54 recognizes the state of the periphery around the host vehicle 10. For example, based on the image information acquired by the cameras 18, the information acquired by the radar devices 24 and the LIDAR devices 26, and the external environmental information acquired by the first communication device 30, the external environment recognition unit 54 recognizes the existence, the position, the size, the type, and the forward traveling direction of other vehicles 100 which are traveling or stopped in the vicinity of the host vehicle 10, together with recognizing the distance and the relative velocity between the host vehicle 10 and the other vehicles 100. Further, on the basis of the image information acquired by the cameras 18, the information acquired by the radar devices 24 and the LIDAR devices 26, the map information 42, and the external environmental information acquired by the second communication device 32, the external environment recognition unit 54 recognizes the shape, the type, and the position of recognition target objects included within the road environment. Further, on the basis of the image information acquired by the cameras 18 or the external environmental information acquired by the second communication device 32, the external environment recognition unit 54 recognizes the signals (a forward traveling permissible state, a forward traveling prohibited state) that are indicated by the traffic signals.

Based on information output from the map unit 34 and the navigation device 36, the host vehicle position recognition unit 56 recognizes the position of the host vehicle 10.

The action planning unit 58 plans an optimal action for the host vehicle 10, on the basis of recognition results from the external environment recognition unit 54 and the host vehicle position recognition unit 56, and detection information and stored information from the input system device group 14. The action planning unit 58 sets travel trajectories and target velocities in accordance with events occurring at respective points in time.

The vehicle control unit 64 controls the output system device group 70 on the basis of the actions planned by the action planning unit 58. For example, the vehicle control unit 64 calculates steering command values corresponding to the travel trajectory set by the action planning unit 58, and acceleration/deceleration command values in accordance with the target velocity, and outputs control instructions with respect to the driving force output device 72, the steering device 74, and the braking device 76.

The notification control unit 66 outputs notification instructions to the notification device 78 based on the notification actions planned by the action planning unit 58.

Apart from the various programs executed by the computation device 52, the storage device 68 shown in FIG. 1 stores numerical values used for comparisons and determinations made in the respective processes.

### 2. Operations of the Vehicle Control Device 12

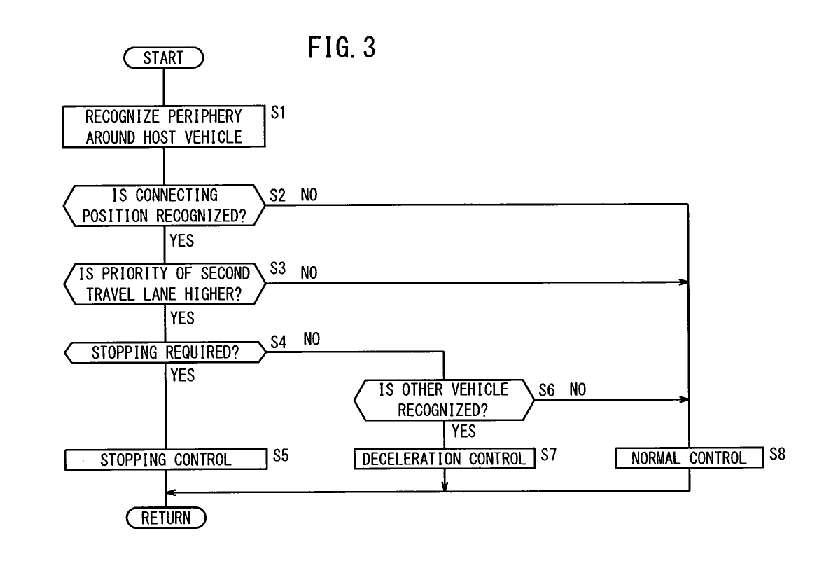

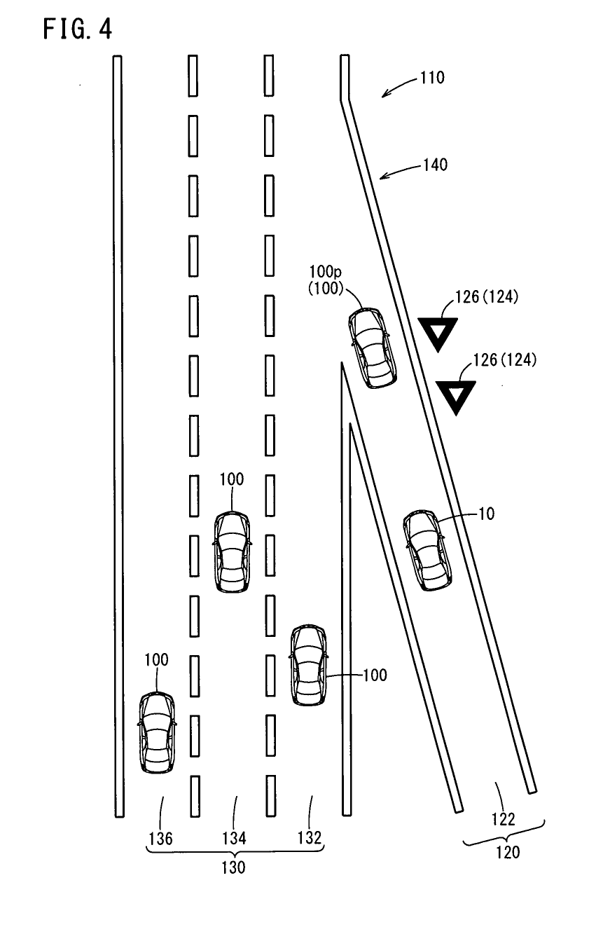

The vehicle control device 12 will now be described with reference to FIG. 3. The process shown in FIG. 3 is executed at predetermined time intervals during a period in which the vehicle control device 12 performs automated driving. Moreover, in the following description, as shown in FIG. 4, a situation is assumed in which the two travel paths are connected (which includes intersecting and merging with one another). In FIG. 4, a first travel path 120 has one travel lane (a first lane 122). A second travel path 130 includes three travel lanes (a second lane 132, a third lane 134, and a fourth lane 136) which have the same forward traveling direction. The first travel path 120 and the second travel path 130 connect with one another at a connecting position 140. More specifically, the first lane 122 of the first travel path 120 merges with the second lane 132 located on a rightmost side of the second travel path 130. Two indicators 124 are installed on the side of the first travel path 120 and in front of the connecting position 140. The indicators 124 are road signs 126 (temporary stop, yield, etc.) which are indicative of a traffic regulation in which the priority of the second travel path 130 is higher than the priority of the first travel path 120. The host vehicle 10 travels in the first lane 122 and the other vehicles 100 travel in the second lane 132, the third lane 134, and the fourth lane 136.

In step S1, the external environment recognition unit 54 recognizes the state of the periphery around the host vehicle 10 on the basis of the latest information output from the input system device group 14.

In the case that the external environment recognition unit 54 recognizes the connecting position 140 within a predetermined distance in the forward traveling direction of the host vehicle 10 (step S2: YES), the process transitions to step S3. On the other hand, in the case that the connecting position 140 is not recognized (step S2: NO), the process transitions to step S8.

Based on at least one of the image information acquired by the cameras 18, the external environmental information acquired by the second communication device 32, and information related to the priority included in the map information 42, the external environment recognition unit 54 recognizes the traffic regulation by which the priority of the travel paths is determined. In the case that the traffic regulation is recognized on the basis of the image information, the external environment recognition unit 54 identifies the road signs 126 using an image recognition technique such as template matching. For example, as shown in FIG. 4, in the case that road signs 126 which are installed on the side of the first travel path 120 or road signs 126 facing toward the first travel path 120 are identified, the external environment recognition unit 54 recognizes that the priority of the second travel path 130 is higher. In contrast thereto, in the case that road signs 126 which are installed on the side of the second travel path 130 or road signs 126 facing toward the second travel path 130 are identified, the external environment recognition unit 54 recognizes that the priority of the first travel path 120 is higher. Moreover, in the case that the external environment recognition unit 54 is incapable of recognizing the traffic regulation by which the priority is determined on the basis of any one of the image information, the external environmental information, and the map information 42, the external environment recognition unit 54 estimates the priority on the basis of the types of the travel paths, the number of lanes, the widths of the travel paths, and the like. In the case that the external environment recognition unit 54 recognizes that the priority of the second travel path 130 is higher (step S3: YES), the process transitions to step S4. On the other hand, in the case that the external environment recognition unit 54 recognizes that the priority of the first travel path 120 is higher (step S3: NO), the process transitions to step S8.

In step S4, the external environment recognition unit 54 recognizes whether or not a traffic regulation has required that the host vehicle 10, which is traveling in the first travel path 120, come to a stop. In the case there is a traffic rule which has required the host vehicle 10 to stop (step S4: YES), the process transitions to step S5. On the other hand, in the case there is not a traffic rule which has required the host vehicle 10 to stop (step S4: NO), the process transitions to step S6.

Upon transitioning from step S4 to step S5, the action planning unit 58 determines an amount of deceleration corresponding to the traffic regulation, which is an amount of deceleration in order to cause the host vehicle 10 to come to a stop at a predetermined position before reaching the connecting position 140. A method of determining the amount of deceleration will be described in item [3] below. The action planning unit 58 sets the target velocity and the travel trajectory in accordance with the amount of deceleration until the host vehicle 10 comes to a stop. The vehicle control unit 64 calculates a deceleration command value and a steering command value required in order to cause the host vehicle 10 to travel at the target velocity along the travel trajectory, and outputs the command values to the output system device group 70. The driving force output device 72, the steering device 74, and the braking device 76 operate in accordance with the instructions output from the vehicle control unit 64. As a result, while decelerating, the host vehicle 10 comes to a stop at the predetermined position before reaching the connecting position 140. In addition, if the external environment recognition unit 54 no longer recognizes the other vehicle 100 that is traveling in the second lane 132 toward the connecting position 140 and entering within a predetermined distance of the connecting position 140, the action planning unit 58 causes the host vehicle 10 to enter into the second travel path 130.

Upon transitioning from step S4 to step S6, the external environment recognition unit 54 recognizes whether or not there is another vehicle 100 traveling in the second lane 132 toward the connecting position 140 and entering within a predetermined distance of the connecting position 140. In the case that the external environment recognition unit 54 recognizes the other vehicle 100 (step S6: YES), the process transitions to step S7. On the other hand, in the case that the other vehicle 100 is not recognized (step S6: NO), the process transitions to step S8.

Upon transitioning from step S6 to step S7, the action planning unit 58 determines an amount of deceleration of the host vehicle 10 corresponding to the traffic regulation, until the external environment recognition unit 54 no longer recognizes the other vehicle 100 traveling in the second lane 132 toward the connecting position 140 and entering within the predetermined distance of the connecting position 140. However, in the case that the external environment recognition unit 54 still recognizes the other vehicle 100 at a point in time when the host vehicle 10 has arrived at the second travel path 130, the action planning unit 58 determines an amount of deceleration in order to cause the host vehicle 10 to come to a stop before reaching the connecting position 140. A method of determining the amount of deceleration will be described in item [3] below. The vehicle control unit 64 calculates a deceleration command value and a steering command value, and outputs the command values to the output system device group 70. The driving force output device 72, the steering device 74, and the braking device 76 operate in accordance with the instructions output from the vehicle control unit 64. As a result, the host vehicle 10 decelerates, and depending on the situation, stops before reaching the connecting position 140. In addition, if the external environment recognition unit 54 no longer recognizes the other vehicle 100 that is traveling in the second lane 132 toward the connecting position 140 and entering within a predetermined distance of the connecting position 140, the action planning unit 58 causes the host vehicle 10 to enter into the second travel path 130.

Upon transitioning to step S8 from step S2, step S3, or step S6, the action planning unit 58 decides to cause the host vehicle 10 to travel in a normal manner. At this time, the action planning unit 58 sets the travel trajectory and the target velocity for causing the host vehicle 10 to travel on the planned route or along the road. The vehicle control unit 64 calculates the acceleration/deceleration command value and the steering command value, and outputs the command values to the output system device group 70. The driving force output device 72, the steering device 74, and the braking device 76 operate in accordance with the instructions output from the vehicle control unit 64.

### 3. Method of Determining Amount of Deceleration

In a normal situation, the action planning unit 58 determines the amount of deceleration in accordance with the travel velocity of the host vehicle 10, and the distance to a target stop position or the position of another vehicle 100 traveling in front of the host vehicle 10. In contrast thereto, in steps S5 and S7 shown in FIG. 3, with reference to the amount of deceleration that is used in a normal situation, and on the basis of the information recognized by the external environment recognition unit 54, the action planning unit 58 determines the amount of deceleration of the host vehicle 10 corresponding to the traffic regulation. Moreover, the term “amount of deceleration” as used herein refers to a rate of reducing velocity, or a difference in velocity before and after decelerating, or the like.

The action planning unit 58 determines an amount of deceleration of the host vehicle 10 corresponding to the traffic regulation on the basis of at least one item of information from among a situation of the other vehicles 100 traveling in the second travel path 130, the number of the other vehicles 100 traveling in the second travel path 130, a speed limit of the second travel path 130, and environmental information of the second travel path 130 recognized by the external environment recognition unit 54. The situation of the other vehicles 100 refers to the travel positions and the travel velocities of the other vehicles 100 that are traveling in the second travel path 130 toward the connecting position 140. Further, the environmental information of the second travel path 130 refers to a curvature of the second travel path 130, a number of fallen objects, an average speed of the other vehicles 100 that are traveling at that time, etc. The external environment recognition unit 54 recognizes such information on the basis of at least one of the image information, the detection results of the radar devices 24 or the LIDAR devices 26, the external environmental information acquired by the first communication device 30, and the external environmental information acquired by the second communication device 32.

The action planning unit 58 determines a coefficient based on the various types of information recognized by the external environment recognition unit 54, and determines a corrected amount of deceleration by multiplying the determined coefficient by a reference amount of deceleration. As the coefficient increases, the amount of deceleration increases, and the host vehicle 10 approaches the connecting position 140 at a lower velocity.

For example, the action planning unit 58 increases the coefficient as the travel positions of the other vehicles 100 traveling toward the connecting position 140 become closer in proximity to the host vehicle 10. At this time, the coefficient is further increased as the other vehicles 100 are traveling in lanes located more closely to the first travel path 120. The action planning unit 58 also increases the coefficient as the travel velocity of the other vehicles 100 becomes higher. Further, the action planning unit 58 increases the coefficient as the number of the other vehicles 100 increases. The action planning unit 58 also increases the coefficient as the speed limit of the second travel path 130 becomes higher. Further, the action planning unit 58 increases the coefficient as a curvature of the connecting position 140 or a curvature of the second travel path 130 before and after the connecting position 140 becomes greater. Further, the action planning unit 58 increases the coefficient as the number of fallen objects increases. Further, the action planning unit 58 increases the coefficient as the average velocity of the other vehicles 100 traveling at that time becomes higher in velocity.

### 4. Modified Examples and the Like

Various additional embodiments or modified examples can be considered in relation to the first embodiment. The features of such modified examples will be described below.

### [4.1. Example 1]

In a situation in which it is difficult to recognize the second travel path 130 from the first travel path 120, the external environment recognition unit 54 is incapable of detecting the traffic participants that exist in the second travel path 130. In order to prepare for such a situation, the following features may be implemented. In the case of a situation in which the traffic participants existing in the second travel path 130 cannot be detected, and in this case it is possible to recognize another vehicle 100, and more specifically a preceding vehicle 100p traveling in front of the host vehicle 10, the external environment recognition unit 54 determines the amount of deceleration of the preceding vehicle 100p. In this case, the action planning unit 58 determines the amount of deceleration of the host vehicle 10 on the basis of the amount of deceleration of the preceding vehicle 100p.

### [4.2. Example 2]

There are situations in which a plurality of road signs 126 are disposed on the side of the first travel path 120. In order to prepare for such a situation, the following features may be implemented. Based on the image information, the external environment recognition unit 54 recognizes the road signs 126 and the number of such road signs 126. In accordance with the number of the road signs 126, the action planning unit 58 changes the distance that the host vehicle 10 travels in a state of being decelerated. In this case, the distance is made greater as the number of such road signs 126 increases.

### [4.3. Example 3]

It is also possible for the coefficient to be changed in accordance with the amount of traffic in the second travel path 130. For example, the external environment recognition unit 54 recognizes the amount of traffic in the second travel path 130 on the basis of the external environmental information acquired by the second communication device 32. The action planning unit 58 changes the coefficient in accordance with the amount of traffic in the second travel path 130. In this case, the coefficient is made greater as the amount of traffic increases.

### [4.4. Example 4]

There are situations in which it is difficult to recognize the first travel path 120 from the second travel path 130, such as when there is a difference in height between the first travel path 120 and the second travel path 130. In order to prepare for such a situation, the following features may be implemented. The external environment recognition unit 54 recognizes the position of the first travel path 120 and the position of the second travel path 130 on the basis of the map information 42 or the like. The action planning unit 58 determines a degree of recognizability which indicates a degree to which the first travel path 120 can be recognized from the second travel path 130 on the basis of the position of the first travel path 120 and the position of the second travel path 130. For example, the degree of recognizability is lowered by determining a situation in which recognition becomes more difficult as the difference in height becomes wider. Further, in the case that an obstacle is confirmed between the first travel path 120 and the second travel path 130 on the basis of the map information 42 or the like, a situation is determined in which recognition of the first travel path 120 is difficult, and the degree of recognizability is lowered. The action planning unit 58 changes the coefficient in accordance with the degree of recognizability. In this case, the coefficient is made greater as the degree of recognizability becomes lower.

### [4.5. Example 5]

It is also possible to change the amount of deceleration of the host vehicle 10 in accordance with the types of the first travel path 120 and the second travel path 130, for example, in accordance with a difference between an expressway and a general road. In order to prepare for such a situation, the following features may be implemented. The external environment recognition unit 54 recognizes the types of the first travel path 120 and the second travel path 130 on the basis of the map information 42. The action planning unit 58 changes the coefficient in accordance with the types of the first travel path 120 and the second travel path 130. In the case of distinguishing the types between an expressway and a general road, the coefficient is increased for the case of the expressway.

### [4.6. Example 6]

In the case that the host vehicle 10 is made to stop before reaching the second travel path 130 in steps S5 and S7 shown in FIG. 3, the travel control may be carried out in the following manner. The action planning unit 58 determines to alternately perform stopping and traveling of the host vehicle 10 in the first travel path 120, until the external environment recognition unit 54 recognizes that there is no other vehicle 100 traveling in the second travel path 130 toward the connecting position 140. The vehicle control unit 64 calculates the acceleration/deceleration command value and the steering command value, and outputs the command values to the output system device group 70. The driving force output device 72, the steering device 74, and the braking device 76 operate in accordance with the instructions output from the vehicle control unit 64. At this time, the host vehicle 10 gradually advances by repeating a travel operation and a stopping operation.

### [4.7. Example 7]

When the host vehicle 10 is made to decelerate, an appropriate deceleration is decided in accordance with the travel velocity prior to deceleration of the host vehicle 10. Therefore, the following features may be implemented. The action planning unit 58 changes the coefficient in accordance with the travel velocity of the host vehicle 10 before the external environment recognition unit 54 recognizes the traffic regulation, or a speed limit of the first travel path 120 that is recognized by the external environment recognition unit 54. In this case, the coefficient is made greater as the travel velocity or the speed limit increases.

In addition to the road signs 126, the external environment recognition unit 54 is capable of recognizing road markings and traffic signals that indicate the priorities.

### 5. Summary of the First Embodiment

The vehicle control device 12 according to the present embodiment is equipped with the external environment recognition unit 54 that recognizes the state of the periphery around the host vehicle 10, the action planning unit 58 that determines an action of the host vehicle 10 on the basis of the recognition result of the external environment recognition unit 54, and the vehicle control unit 64 that carries out the travel control for the host vehicle 10 on the basis of the content of the action planned by the action planning unit 58. In the case that the external environment recognition unit 54 recognizes the first travel path 120 in which the host vehicle 10 travels, the second travel path 130 that connects with the first travel path 120, and the traffic regulation (the road signs 126, etc.) which determines that the priority of the second travel path 130 is higher than the priority of the first travel path 120, the action planning unit 58 determines the amount of deceleration of the host vehicle 10 corresponding to the traffic regulation, on the basis of at least one item of information from among a situation of the other vehicles 100 traveling in the second travel path 130, a number of the other vehicles 100 traveling in the second travel path 130, the speed limit of the second travel path 130, and environmental information of the second travel path 130 recognized by the external environment recognition unit 54.

In accordance with the above-described configuration, by determining the amount of deceleration of the host vehicle 10 on the basis of the condition of the second travel path 130, which has a higher priority than the first travel path 120 in which the host vehicle 10 travels, it is possible for the host vehicle 10 to be decelerated appropriately before reaching the second travel path 130.

In the case of recognizing a situation in which a traffic participant existing in the second travel path 130 cannot be detected, the external environment recognition unit 54 recognizes an amount of deceleration of the preceding vehicle 100p traveling in front of the host vehicle 10. The action planning unit 58 determines the amount of deceleration of the host vehicle 10 on the basis of the amount of deceleration of the preceding vehicle 100p.

In accordance with the above-described configuration, by determining the amount of deceleration of the host vehicle 10 on the basis of the preceding vehicle 100p, it is possible for the host vehicle 10 to be decelerated appropriately before reaching the second travel path 130. Further, the amount of deceleration itself can be easily determined.

The vehicle control device 12 is further equipped with the cameras 18 which obtain image information by capturing images of the indicators 124 that indicate the traffic regulation. In the case that the external environment recognition unit 54 recognizes the traffic regulation on the basis of the image information, the action planning unit 58 changes the distance that the host vehicle 10 travels in a state of being decelerated in accordance with the number of the indicators 124.

As the number of the indicators 124 such as road signs 126 or the like increases, the distance that the host vehicle 10 travels in the decelerated state increases. In accordance with the above-described configuration, by changing the distance that the host vehicle 10 travels in the decelerated state in accordance with the number of the indicators 124, it is possible for the host vehicle 10 to be decelerated more appropriately before reaching the second travel path 130.

The vehicle control device 12 further comprises the host vehicle communication device (second communication device 32) that performs communications with an external communication device (the roadside communication devices 112) disposed externally of the host vehicle 10 and obtains external environmental information which includes information on the amount of traffic. The external environment recognition unit 54 recognizes the amount of traffic in the second travel path 130 on the basis of the external environmental information. The action planning unit 58 changes the amount of deceleration of the host vehicle 10 in accordance with the amount of traffic in the second travel path 130.

In accordance with the above-described configuration, by changing the amount of deceleration in accordance with the amount of traffic in the second travel path 130, it is possible to decelerate the host vehicle 10 more appropriately before reaching the second travel path 130.

The external environment recognition unit 54 recognizes the position of the first travel path 120 and the position of the second travel path 130. The action planning unit 58 determines a degree of recognizability which indicates a degree to which the first travel path 120 can be recognized from the second travel path 130 on the basis of the position of the first travel path 120 and the position of the second travel path 130, and changes the amount of deceleration of the host vehicle 10 in accordance with the degree of recognizability.

In a situation in which it is difficult to recognize the first travel path 120 from the second travel path 130, the other vehicle 100 may recognize the host vehicle 10 for the first time in the vicinity of the connecting position 140 between the first travel path 120 and the second travel path 130. At this time, if the travel velocity of the host vehicle 10 is high, there is a possibility that an occupant of the other vehicle 100 may operate the brakes rapidly or on the spur of the moment. Upon doing so, the flow of traffic in the second travel path 130 is obstructed. In accordance with the above-described configuration, by changing the amount of deceleration in accordance with the degree to which the first travel path 120 can be recognized from the second travel path 130, it is possible to decelerate the host vehicle 10 more appropriately before reaching the second travel path 130, and the flow of traffic in the second travel path 130 can be maintained. The vehicle control unit 64 further comprises the map storage unit (map unit 34, etc.) in which the map information 42 is stored including information indicative of the type of the road 110. The external environment recognition unit 54 recognizes the types of the first travel path 120 and the second travel path 130 on the basis of the map information 42. The action planning unit 58 changes the amount of deceleration of the host vehicle 10 in accordance with the types of the first travel path 120 and the second travel path 130.

The appropriate amount of deceleration differs between a case in which merging with a main line (the second travel path 130) takes place at an expressway, and a case in which merging with the main line takes place at a general road. In accordance with the above-described configuration, by determining the amount of deceleration in accordance with the types (an expressway, a general road) of the first travel path 120 and the second travel path 130, it is possible to decelerate the host vehicle 10 more appropriately before reaching the second travel path 130. In the case that the vehicle control unit 64 has caused the host vehicle 10 to stop before reaching the second travel path 130, the action planning unit 58 determines to alternately perform stopping and traveling of the host vehicle 10 in the first travel path 120, until the external environment recognition unit 54 recognizes that other vehicles 100 do not exist which are traveling in the second travel path 130 toward the connecting position 140 between the first travel path 120 and the second travel path 130.

In the case that the host vehicle 10 stops before reaching the connecting position 140 between the first travel path 120 and the second travel path 130, in certain cases, it may be difficult to recognize the other vehicle 100 from the stopped position. In this case, it is preferable to cause the host vehicle 10 to move to a position where the other vehicle 100 can be more easily recognized. In the above-described configuration, it is determined to alternately perform stopping and traveling of the host vehicle 10 in the first travel path 120, and by executing such an action, it is possible to cause the host vehicle 10 to be moved to a position where it is easy to recognize the presence or absence of the other vehicle 100 in the vicinity of the connecting position 140.

The action planning unit 58 changes the amount of deceleration of the host vehicle 10 in accordance with a travel velocity of the host vehicle 10 before the external environment recognition unit 54 recognizes the traffic regulation, or a speed limit of the first travel path 120 that is recognized by the external environment recognition unit 54.

In the case that the travel velocity of the host vehicle 10 is decelerated to a predetermined velocity or less, the amount of deceleration differs depending on the travel velocity prior to deceleration of the host vehicle 10. In accordance with the above-described configuration, by determining the amount of deceleration in accordance with the travel velocity of the host vehicle 10 or the speed limit of the first travel path 120, it is possible to decelerate the host vehicle 10 more appropriately before reaching the second travel path 130.

### B. Second Embodiment

In certain cases, a lower limit value of a distance at which an obstacle may approach or come into proximity to the host vehicle 10 is set. In the present specification, such a lower limit value is referred to as an approach enabled distance A. An embodiment involving such an approach enabled distance A will be described below. As for the configuration of the host vehicle 10, the configuration shown in FIGS. 1 and 2 can be used.

In the present embodiment, a predetermined distance A1 is stored as the approach enabled distance A in the storage device 68. In the case that the distance between the host vehicle 10 and an obstacle such as another vehicle 100 which is recognized by the external environment recognition unit 54 becomes less than or equal to the predetermined distance A1, the action planning unit 58 carries out an action to avoid an approach between the host vehicle 10 and the obstacle. More specifically, a decision is made to perform a deceleration control of the host vehicle 10.

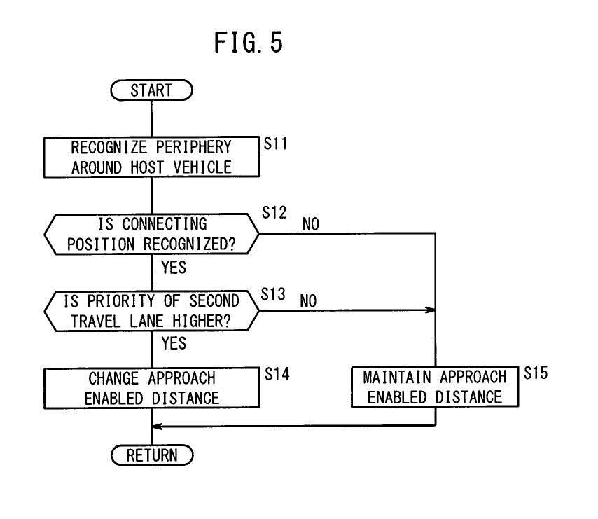

Operations of the vehicle control device 12 according to the second embodiment will be described with reference to FIG. 5. Among the process steps shown in FIG. 5, the processes of steps S11 to S13 are the same as the processes of steps S1 to S3 shown in FIG. 3, and therefore, description of these steps will be omitted.

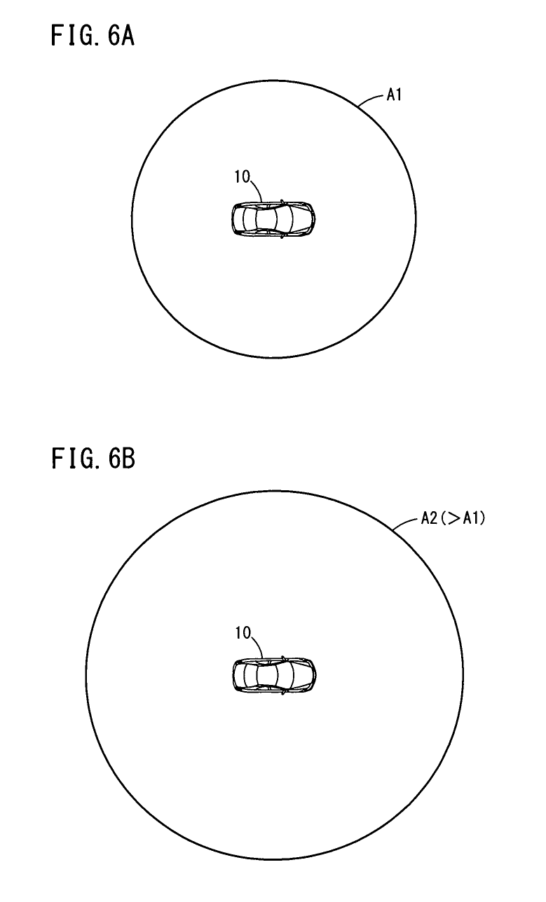

In the case of transitioning from step S13 to step S14, and more specifically, in the case that the external environment recognition unit 54 recognizes a traffic regulation by which the priority of the second travel path 130 is higher than the priority of the first travel path 120, the action planning unit 58 sets the approach enabled distance A. For example, the predetermined distance A1 shown in FIG. 6A is expanded to the predetermined distance A2 (which is greater than A1) shown in FIG. 6B. On the other hand, in the case of transitioning from step S13 to step S15, and more specifically, in the case that the external environment recognition unit 54 does not recognize a traffic regulation by which the priority of the second travel path 130 is higher than the priority of the first travel path 120, the action planning unit 58 maintains the approach enabled distance A at the predetermined distance A1.

When the approach enabled distance A is expanded to the predetermined distance A2, as in step S14, then if the distance between the host vehicle 10 and the other vehicle 100 becomes less than or equal to the predetermined distance A2, the host vehicle 10 is decelerated. Stated otherwise, the timing of the deceleration becomes earlier than if the approach enabled distance A were maintained at the predetermined distance A1.

The vehicle control device 12 according to the second embodiment is equipped with the external environment recognition unit 54 that recognizes the state of the periphery around the host vehicle 10, the action planning unit 58 that determines an action of the host vehicle 10 on the basis of the recognition result of the external environment recognition unit 54, and the vehicle control unit 64 that carries out the travel control for the host vehicle 10 on the basis of the determination result of the action planning unit 58. In the case that the external environment recognition unit 54 recognizes the first travel path 120 in which the host vehicle 10 travels, and the second travel path 130 that connects with the first travel path 120, the action planning unit 58 changes a distance (the approach enabled distance A) up to which it is acceptable for the host vehicle 10 to come into proximity with respect to the other vehicles 100 that travel in the second travel path 130, depending on a case of the external environment recognition unit 54 recognizing and a case of the external environment recognition unit 54 not recognizing a traffic regulation by which the priority of the second travel path 130 is higher than the priority of the first travel path 120.

In accordance with the above-described configuration, since the distance (the approach enabled distance A) up to which it is acceptable for the host vehicle 10 to come into proximity with respect to the other vehicles 100 is changed, it is possible to hasten the timing at which the host vehicle 10 begins to decelerate. As a result, it is possible for the host vehicle 10 to be made to decelerate appropriately before reaching the second travel path 130.

The vehicle control device according to the present invention is not limited to the above-described embodiment, and it goes without saying that various additional or alternative configurations could be adopted therein without departing from the essence and gist of the present invention.

What is claimed is:

1. A vehicle control device, comprising:
an external environment recognition unit adapted to recognize a state of a periphery around a host vehicle;
an action planning unit adapted to determine an action of the host vehicle on the basis of a recognition result of the external environment recognition unit; and
a vehicle control unit adapted to carry out a travel control for the host vehicle on the basis of content of the action planned by the action planning unit;
wherein, in the case that the external environment recognition unit recognizes a first travel path on which the host vehicle travels, a second travel path that connects with the first travel path, and a traffic regulation which determines that a priority of the second travel path is higher than a priority of the first travel path,
the action planning unit determines an amount of deceleration of the host vehicle corresponding to the traffic regulation, on the basis of at least one item of information from among a situation of other vehicles traveling in the second travel path recognized by an external environment recognition unit, a number of the other vehicles traveling in the second travel path, a speed limit of the second travel path, and environmental information of the second travel path.

2. The vehicle control device according to claim 1, wherein:
in the case of recognizing a situation in which a traffic participant existing in the second travel path cannot be detected, the external environment recognition unit recognizes an amount of deceleration of a preceding vehicle traveling in front of the host vehicle; and
the action planning unit determines an amount of deceleration of the host vehicle on the basis of the amount of deceleration of the preceding vehicle.

3. The vehicle control device according to claim 1, further comprising:
a camera adapted to capture an image and acquire image information of indicators that indicate the traffic regulation;
wherein, in the case that the external environment recognition unit recognizes the traffic regulation on the basis of the image information, the action planning unit changes a distance that the host vehicle travels in a decelerated state in accordance with a number of the indicators.

4. The vehicle control device according to claim 1, further comprising:
a host vehicle communication device adapted to perform communications with an external communication device disposed externally of the host vehicle, and acquire external environmental information including information of an amount of traffic;
wherein the external environment recognition unit recognizes the amount of traffic in the second travel path on the basis of the external environmental information; and
the action planning unit changes the amount of deceleration of the host vehicle in accordance with the amount of traffic in the second travel path.

5. The vehicle control device according to claim 1, wherein:
the external environment recognition unit recognizes a position of the first travel path and a position of the second travel path; and
the action planning unit determines a degree of recognizability which indicates a degree to which the first travel path can be recognized from the second travel path on the basis of the position of the first travel path and the position of the second travel path, and changes the amount of deceleration of the host vehicle in accordance with the degree of recognizability.

6. The vehicle control device according to claim 1, further comprising:
a map storage unit in which map information is stored including information indicative of a type of road;
wherein the external environment recognition unit recognizes the types of the first travel path and the second travel path on the basis of the map information; and
the action planning unit changes the amount of deceleration of the host vehicle in accordance with the types of the first travel path and the second travel path.

7. The vehicle control device according to claim 1, wherein:
in the case that the vehicle control unit has caused the host vehicle to stop before reaching the second travel path;
the action planning unit determines to alternately perform stopping and traveling of the host vehicle in the first travel path, until the external environment recognition unit recognizes that the other vehicles do not exist which are traveling in the second travel path toward a connecting position between the first travel path and the second travel path.

8. The vehicle control device according to claim 1, wherein the action planning unit changes the amount of deceleration of the host vehicle in accordance with a travel velocity of the host vehicle before the external environment recognition unit recognizes the traffic regulation, or a speed limit of the first travel path that is recognized by the external environment recognition unit.

9. A vehicle control device, comprising:
an external environment recognition unit adapted to recognize a state of a periphery around a host vehicle;
an action planning unit adapted to determine an action of the host vehicle on the basis of a recognition result of the external environment recognition unit; and
a vehicle control unit adapted to carry out a travel control for the host vehicle on the basis of content of the action planned by the action planning unit;
wherein, in the case that the external environment recognition unit recognizes a first travel path on which the host vehicle travels, and a second travel path that connects with the first travel path,
the action planning unit changes a distance up to which it is acceptable for the host vehicle to come into proximity with respect to other vehicles that travel in the second travel path, depending on a case of the external environment recognition unit recognizing and a case of the external environment recognition unit not recognizing a traffic regulation by which a priority of the second travel path is higher than a priority of the first travel path.
